(19) United States
(12) Patent Application Publication
(10) Pub. No.: US 2002/0197099 A1
(43) Pub. Date: Dec. 26, 2002

(54) Waist connection apparatus for an artificial model

(76) Inventor: Jung-Chang Chiang, Taipei (TW)

Correspondence Address: CONNOLLY BOVE LODGE & HUTZ, LLP, 1220 N MARKET STREET, P O BOX 2207, WILMINGTON, DE, 19899

(21) Appl. No.: 09/888,831

(22) Filed: Jun. 25, 2001

(51) Int. Cl. F16D 1/12; F16D 3/00

(52) U.S. Cl. 403/78

(57) ABSTRACT

A waist connection apparatus for an artificial model comprises an upper and a lower bases respectively, and an upper and a lower engaging disks respectively. The upper and the lower engaging disks are fastened to the upper and the lower bases respectively. The upper and the lower disks provide detachable connecting parts such that the upper and the lower parts of the model can be joined together or separated apart easily. Hence, the waist connection apparatus makes the model possible to be hung up, lean to one side, and many other postures as desired by the need of exhibition. Furthermore, the waist connection apparatus can fit any size of the model as soon as a proper sized waist connection apparatus is replaced.

### BACKGROUND OF THE INVENTION

1. Field of the Invention

The present invention relates to a waist connection apparatus for an artificial model, and, particularly, to a connection apparatus, which is possible to detachably connect the waist part of an artificial model with an upper and a lower halves easily.

2. Description of Related Art

For a clothes maker, the artificial model is an indispensable tool for a fashion exhibition. The artificial model allows a variety of clothes to be presented a real state of being put on in a best way to attract the customers during shopping. Hence, it is very important to the clothes maker whether the model is good or not.

Normally, the conventional model as shown in FIG. 12 is usually divided into an upper part 41 and a lower part 42 with a consideration of setting up, delivery, or inventory. In order to connect the upper part 41 an the lower part 42, adjoining ends thereof provide a joining hole 4101 and a joining protrusion 4202 respectively for engaging with each other.

Of course, the preceding connecting device allows the model halves to detachably engage with each other for putting on clothes, delivering, and setting up as a model. But, the conventional connecting device only provides the model a posture of standup position and it is hard for the conventional device to offer the model other postures such as being hung up, and sitting and leaning one side. For instance, the lower part of the model may loose and drop in case of hanging up the model and may expose a gap between the upper and the lower parts 41, 42 of the model such that the fashion exhibition is harmfully affected.

### SUMMARY OF THE INVENTION

A main object of the present invention is to provide a waist connection apparatus for an artificial model, which can be performed to join the upper and the lower parts of the model firmly in case of different postures of the model being connected.

Another object of the present invention is to provide a waist connection apparatus for an artificial model, which is compatible with different sized models so that it is not required to prepare a lot of connection apparatus for a variety of models in different sizes.

### BRIEF DESCRIPTION OF THE DRAWINGS

The other objects and features of the present invention can be more fully understood by reference to the following description of preferred embodiments and accompanying drawing, in which:

FIG. 1 is a perspective view of a waist connection apparatus for an artificial model according to the present invention;

FIG. 2 is a perspective view illustrating the waist connection apparatus for an artificial model shown in FIG. 1 in use;

FIG. 3 is an exploded perspective view illustrating disassembled parts of the waist connection apparatus for an artificial model shown in FIG. 1;

FIG. 4 is a semi-sectional view of FIG. 2 illustrating a detailed with regard to the waist connection apparatus for an artificial model in use;

FIG. 5 is a perspective view of an insert piece of an insert device used in the waist connection apparatus of the present invention;

FIG. 6 is a fragmentary sectional view illustrating the insert device in detail;

FIG. 7 is a schematic perspective view illustrating an artificial model in a state of being hung up;

FIG. 8 is a schematic perspective view illustrating an artificial model in a state of sitting and leaning to one side;

FIG. 9 is a bottom perspective view of an upper base of the waist connection apparatus according to the present invention;

FIG. 10 is a perspective view of a support device for the upper body part of a model according to the present invention;

FIG. 11 is a perspective view illustrating the support device shown in FIG. 10 being used for the upper body part of a model in case of exhibition; and

FIG. 12 is a schematic plan view of a conventional waist connection device for an artificial model.

### DETAILED DESCRIPTION OF THE PREFERRED EMBODIMENT

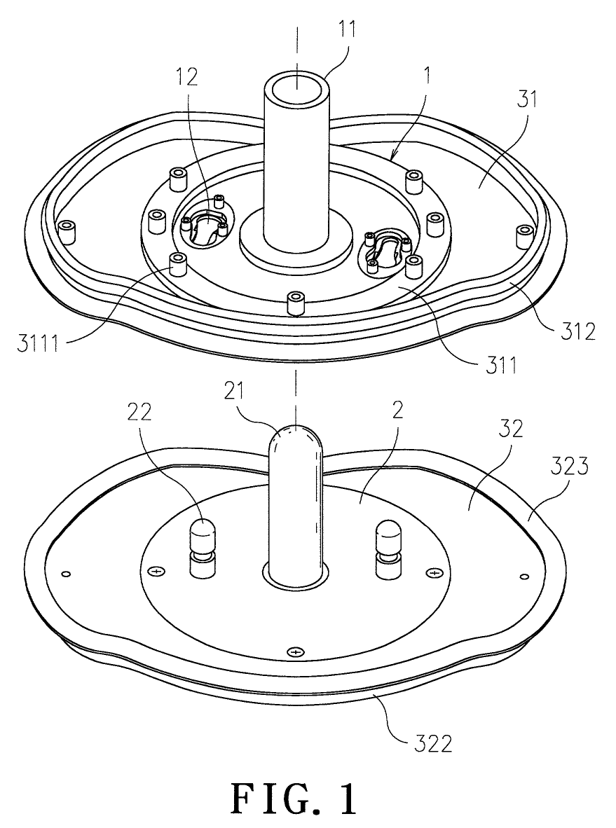

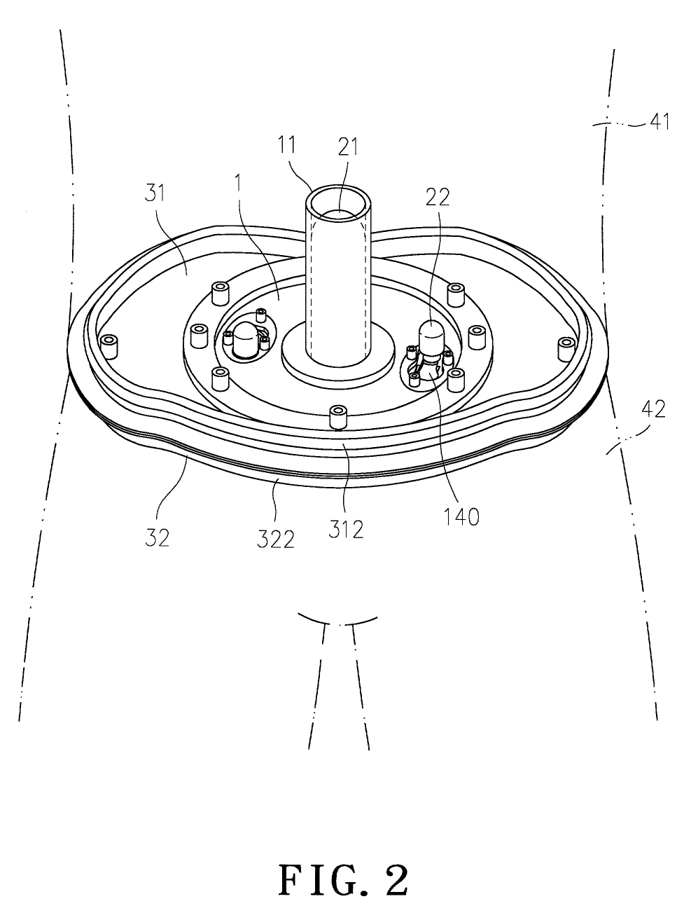

Referring to FIGS. 1 to 11, a waist connection apparatus for an artificial model according to the present invention comprises an upper base 31, a lower base 32, an upper disk 1, and a lower disk 2.

Wherein, the upper and the lower bases 31, 32 at the peripheries thereof provide a fitting ring 312, 322 for fitting with an upper part 41 and a lower part 42 of the model respectively such that both joining surfaces respectively on the upper part 41 and the lower part 42 can be in conjunction with each other. It is noted that the fitting rings 312, 322 are made in accordance with the standardized specification so that both the fitting rings 312, 322 are suitable for any size of the model, and it is possible for the fitting rings 312, 322 to be disposed interchangeably. The upper and the lower bases 31, 32 provide a respective rim surface 313, 323 to slightly jut outward and to face to each other such that there is a gap between the upper and the lower bases 31, 32 as soon as the rim surfaces 313, 323 contact with each other. In this way, a neat fit can be obtained between the upper and the lower bases 31, 32.

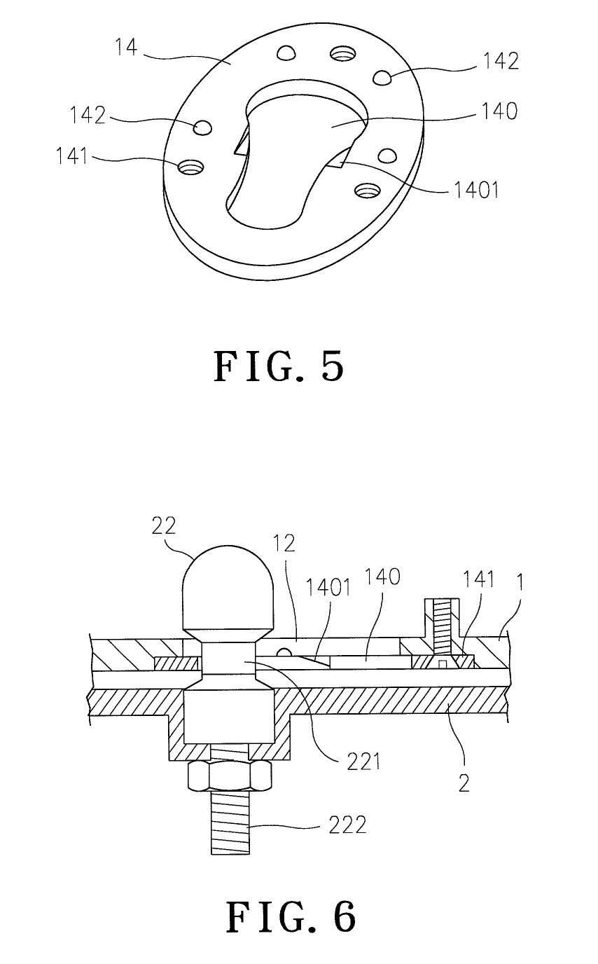

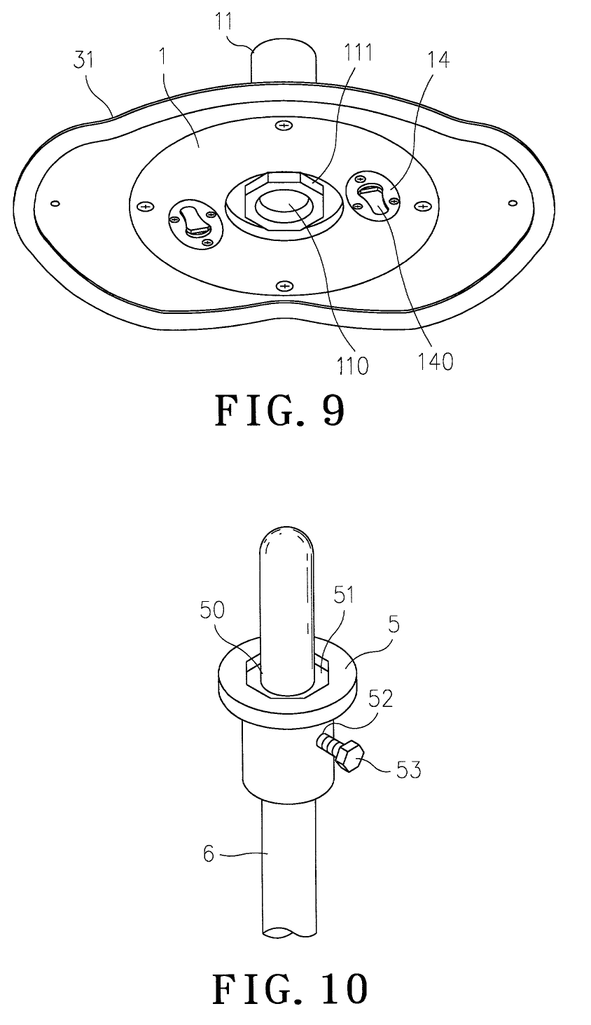

The upper disk 1 at the center thereof has locating tube 11 with a fitting hole 110 and two opposite elongated openings 12 are provided on the upper disk 1. Each elongated opening 12 at the bottom thereof has a counter bore with a plurality of threaded fixing holes 121. Two locating pieces 14 are provided to attach to the elongated openings 12 and each locating piece 14 has a shape and a thickness corresponding to the counter bore and provides an elongated insert hole 140 and a plurality of threaded holes 141 corresponding the elongated opening 12 and the fixing holes 121 respectively. Furthermore, the locating piece 14 provides a plurality of raised spots 142 too as shown in FIG. 5, and the insert hole 140 is provided to have a large diameter section joining a small diameter section for fitting with the neck section 221 on each insert 22, which is mounted on the lower disk 2. The raised spots 142 on the respective locating piece 14 can enhance the insert 22 to perform an engagement feasibly. The bottom of the upper disk 1 may mount a polygon fitting projection 111 as shown in FIG. 9.

The lower base 32 at the center thereof provides a base hole 320 and a locating recess 321 surrounds the base hole 320 and a plurality of threaded holes 3211 are disposed circumferentially on the locating recess 321.

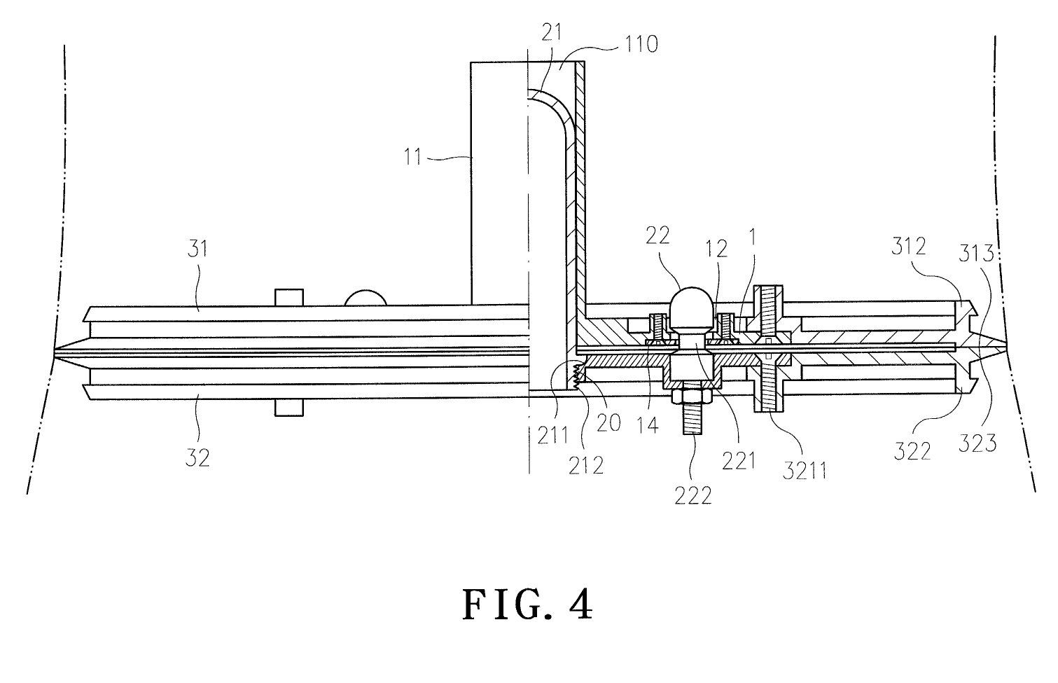

The lower disk 2 at the center thereof provides a threaded fitting bore 20 to engage with a guide post 21 by way of a lower screw part 212 being fastened to the fitting bore 20. A collar 211 is disposed next to the screw part 212 to assure the engagement between the fitting bore 20 and the guide post 21. Two inserts 22 are disposed oppositely with respect to the guide post 21 on the lower disk 2 as shown in FIG. 4 to correspond to the insert hole 140 of the respective locating piece 14. It has been mentioned that each insert 22 provides a neck section 221.

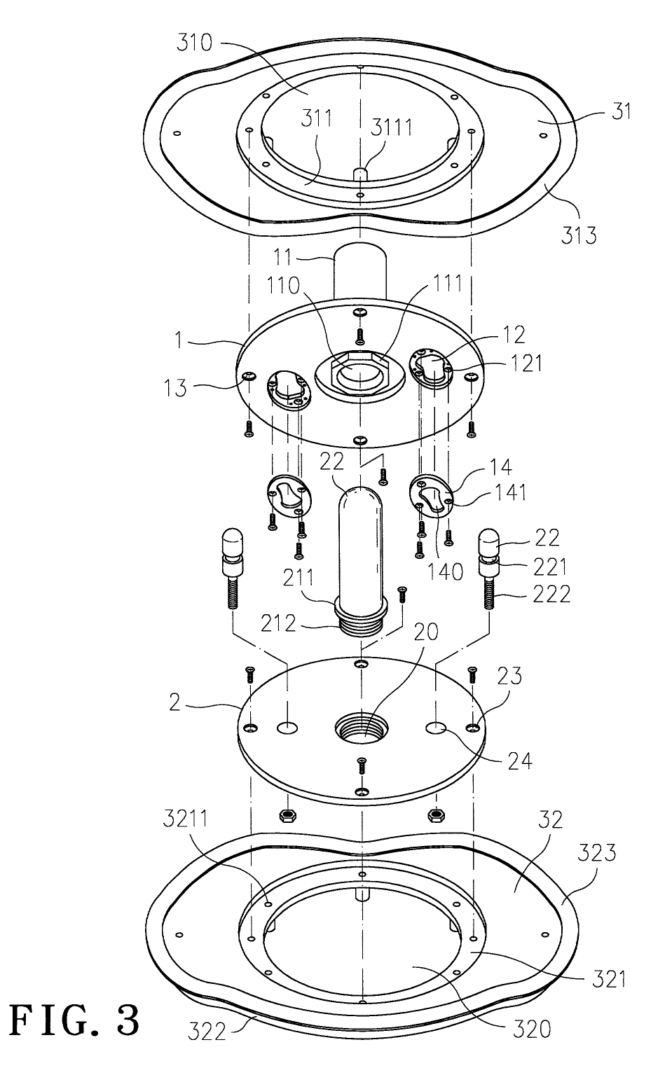

A plurality of threaded holes 23 are disposed circumferentially corresponding to the threaded holes 3211 on the locating recess 321 of the lower base 32 such tat the lower disk 2 can be fixed to the locating recess 321. The lower disk 2 has two engaging holes 24 for the inserts 22 to be fastened to the lower disk 2 by way of nuts engaging lower threaded rod parts of the inserts 22 as shown in FIG. 3.

The threaded holes 13, 23, 3111, 3211 on the upper disk 1, the lower disk 2, the upper base 31, and the lower base 32 are equally spaced apart such that the threaded holes 13, 23, 3111, 3211 can be aligned as desired to decide the angular positions of the inserts 22.

The preceding structure of the waist connection apparatus has the upper and the lower bases 31, 32 be preset on the upper part and the lower part 41, 42 of the model and the upper and the lower disks 1, 2 be fastened to the upper and the lower bases 31, 32 by way of screws respectively. In this way, the locating tube 11 on the upper part 41 of the model fits with the guide post 21 on the lower part 42 of the model and the inserts 22 are inserted into the elongated openings 12 on the upper disk 1. After the inserts being inserted into the elongated openings 12, the inserts 22 may slide into the small diameter section of the insert holes 140 on the locating pieces 14 respectively from the large diameter section as soon as the upper disk 1 is moved to rotate slightly. The inserts 22 are restricted in the insert holes 140 so that the upper part 41 and the lower part 42 of the model can be in conjunction with each other firmly in accordance as expected.

The insert hole 140 of the respective locating piece 14 in the upper disk 1 at the junctions of the big hole part and the small hole part thereof provide a sharpened spot 1401 respectively such that it is much easily for the neck section 221 of the respective insert 22 to be inserted into the insert hole 140 as shown in FIG. 5 and 6.

Due to the guide post 21 engaging with the fitting bore 20 by way of screw threads, it is possible for the guide post 21 to be kept apart from the lower disk 2 during delivery, inventory, and packing so as to save the space occupied by the gross volume of the parts, and the cost related can be lower down.

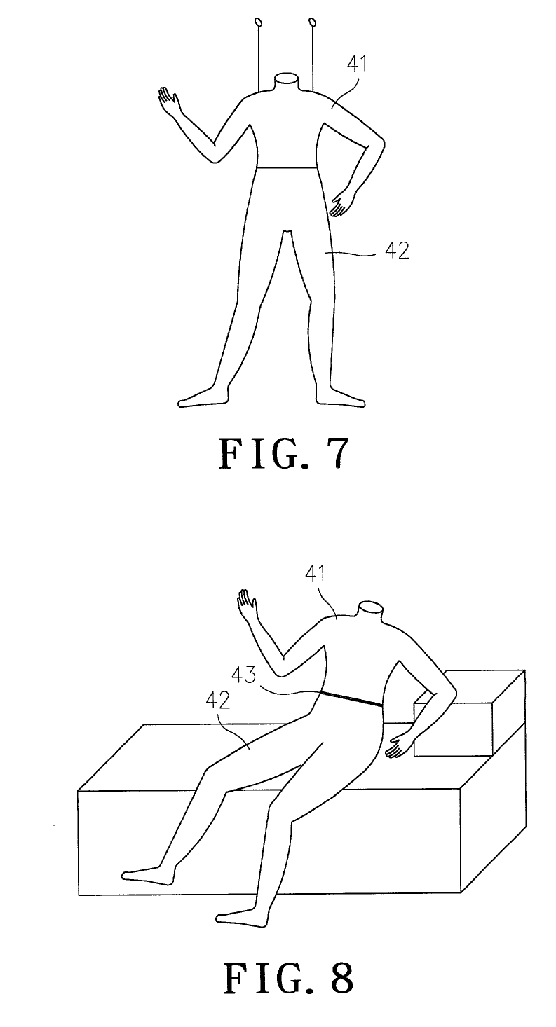

Accordingly, the waist connection apparatus for an artificial model of the present invention can perform a firm and reliable connection between the upper part 41 and the lower part 42 of the model. In case of the model being hung up, it is reliable for the model to connect the upper and the lower parts thereof by way of the waist connection apparatus of the present invention and it does not have to be worried about if the lower part of the model may be loose apart or fall down as shown in FIG. 7.

Furthermore, the inserts 22 and the locating pieces 14 arranged in the waist connection of the present invention restrain each other so that it is not possible to generate a larger gap 43, which affects the outer looking of the model during a fashion exhibition, between the upper part 41 and the lower part 42 as shown in FIG. 8 in case of the model being arranged in a position of leaning one side.

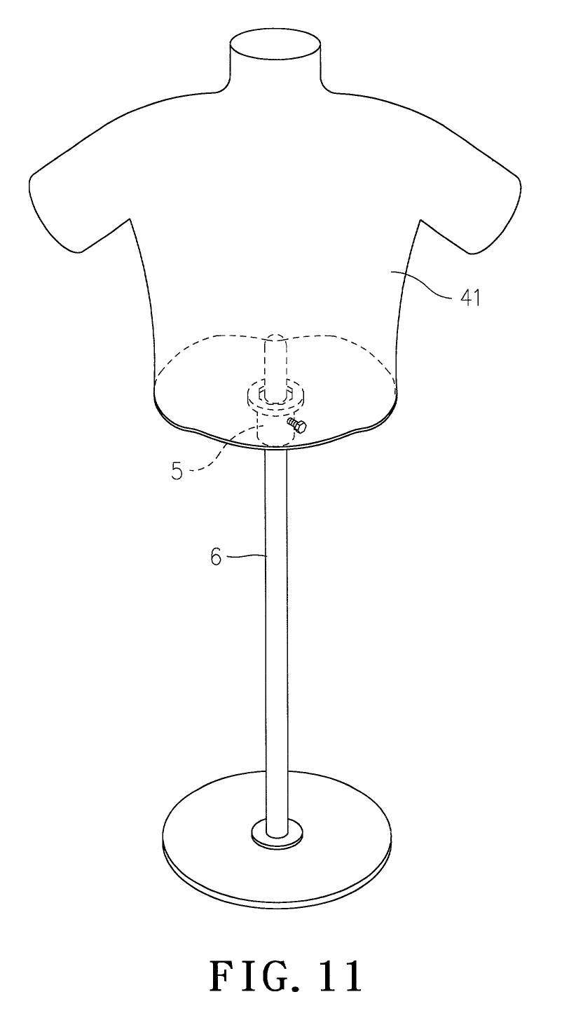

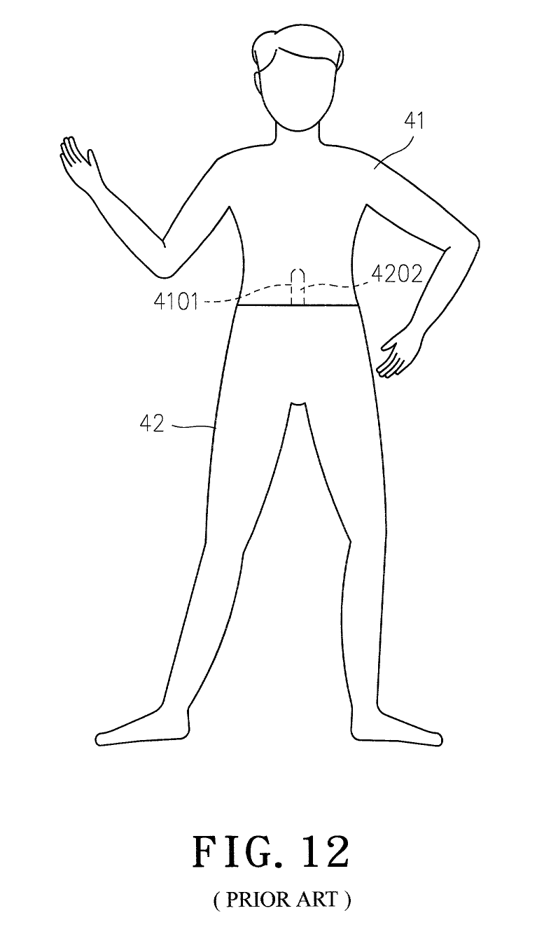

In addition, the polygon fitting projection 111 under the upper disk 1 may be secured to a fitting seat 5 as shown in FIG. 10, and the fitting seat 5 provides a polygon fitting recess 51 corresponding to the fitting projection 111. The fitting seat 5 has a transverse threaded through hole 52 so that the fitting seat 5 can be fixed to a support rod 6. Hence, the upper part 41 of the model can be propped up alone for exhibition as shown in FIG. 11 as soon as the fitting projection 111 fits with the fitting recess 51.

While the invention has been described with reference to a preferred embodiment thereof, it is to be understood that modifications or variations may be easily made without departing from the spirit of this invention, which is defined by the appended claims.

What is claimed is:

1. The waist connection apparatus for an artificial model, comprising:
an upper part of the model;
a lower part of the model;
an upper base with a first periphery part, providing a first fitting ring at the first periphery part to be fixed to the upper part of the model, having a central upper base hole surrounded by a projecting ring seat and a plurality of threaded fixing holes on the ring seat;
a lower base with a second periphery part, providing a second fitting ring at the second periphery part to be fixed to the lower part of the model, having a central lower base hole surrounded by an engaging recess and a plurality of threaded fixing holes too;
an upper engaging disk with a central bore, being fastened to the ring seat of the upper base, providing an upright locating tube extending from the central bore, having two opposite elongated openings with respect to the locating tube, each of the elongated openings being attached a locating piece respectively, the locating piece having an elongated insert hole with a large diameter section adjoining a small diameter section;
a lower engaging disk with a central threaded fitting bore, being fastened to the engaging recess of the lower base, providing a guide post with a threaded end being fastened to the threaded bore, having two opposite inserts being symmetrically disposed with respect to the guide post and corresponding to the respective insert hole of the locating piece, and the respective insert having a neck section;
whereby, as soon as the guide post is inserted into and fits with the locating tube, the inserts on the lower engaging disk pass through the respective inert hole in the locating pieces respectively and the neck section on the respective insert can slide into and engage with the respective insert hole.

2. The waist connection apparatus for an artificial model according to claim 1, wherein the central threaded hole at an upper end thereof provides a shape of counter bore or counter sink to enhance a steady engagement with the guide post.

3. The waist connection apparatus for an artificial model according to claim 1, wherein the insert hole in the respective locating piece provides a sharpened part at two intersections of the large diameter section and the small diameter section such that the neck section of the respective insert can slide into the insert hole easily.

4. The waist connection apparatus for an artificial model according to claim 1, a plurality of raised spots can be provided on the respective locating piece to enhance an engagement of the respective insert with the respective insert hole.

5. The waist connection apparatus for an artificial model according to claim 1, wherein the upper engaging disk at a bottom thereof provides a polygon fitting projection to fit with a polygon fitting recess on a fitting seat for supporting the upper part of the model in case of the single upper part of the model being used for an exhibition.

6. The waist connection apparatus for an artificial model according to claim 1, wherein the upper and the lower bases at the peripheries thereof have a rim surface contacting with each other such that a gap is form between the upper and the lower bases except the trim surfaces to result in a neat contact. the post device respectively for fitting with each other and refraining a relative rotation with respect to each other.
